(19) United States
(12) Patent Application Publication
(10) Pub. No.: US 2013/0041811 A1
(43) Pub. Date: Feb. 14, 2013

(54) UNIFIED PAYMENT SERVICE

(71) Applicants: Anh Vazquez, San Mateo, CA (US); Preet Chhokar, Daly City, CA (US); Andrew Wayman, Austin, TX (US)

(72) Inventors: Anh Vazquez, San Mateo, CA (US); Preet Chhokar, Daly City, CA (US); Andrew Wayman, Austin, TX (US)

(21) Appl. No.: 13/572,191

(22) Filed: Aug. 10, 2012

Related U.S. Application Data
(60) Provisional application No. 61/522,527, filed on Aug. 11, 2011.

(51) Int. Cl. G06Q 20/22; G06Q 40/00

(52) U.S. Cl. 705/39; 705/35

(57) ABSTRACT

A method for unified payment includes identifying a unified account, determining a cash value source of the unified account, determining a non-cash value source of the unified account, and presenting a combined value of the cash value source and the non-cash value source. The combined value is expressed in terms of cash.

### RELATED APPLICATION

This application claims the benefit under 35 U.S.C. §119(e) of U.S. Provisional Application No. 61/522,527 filed Aug. 11, 2011 and entitled “Unified Payment Service.”

### TECHNICAL FIELD OF THE INVENTION

The present invention relates generally to peer-to-peer, peer-to-business, and e-commerce payment systems and, more particularly, to a unified payment service.

### BACKGROUND

Cash may refer to the physical or electronic possession of government-backed or legal tender currency such as in the form of dollar bills, reserve notes, coins, checking accounts, or saving accounts. The electronic transfer of cash from an entity, such as an individual or business, to another entity facilitates payments, commerce, and interpersonal transactions in situations such as person to person, in-person retail, points-of-sale, and online transactions. Debits may form another manner of transferring cash between entities.

Furthermore, value may be implemented in non-cash mechanisms, accounts, virtual goods, or entity-specific credits. Examples of such value implemented in non-cash ways may include vendor affinity points such as frequent flyer miles or frequent guest points, gift certificates for a business or group of businesses, or credits within a virtual environment such as a game or software. In some cases, these examples of non-cash value may be denominated in government-backed currency, but are not legal tender.

### SUMMARY

In one embodiment, a method for unified payment includes identifying a unified account, determining a cash value source of the unified account, determining a non-cash value source of the unified account, and presenting a combined value of the cash value source and the non-cash value source. The combined value is expressed in terms of cash.

In another embodiment, an article of manufacture includes a non-transitory computer readable medium and computer-executable instructions carried on the computer readable medium. The instructions are readable by a processor. The instructions, when read and executed, cause the processor to identify a unified account, determine a cash value source of the unified account, determine a non-cash value source of the unified account, and present a combined value of the cash value source and the non-cash value source. The combined value is expressed in terms of cash.

In yet another embodiment, an apparatus includes a wireless communications module, a processor communicatively coupled to the wireless communications module, a non-transitory computer readable medium, and computer-executable instructions carried on the computer readable medium. The instructions are readable by the processor. The instructions, when read and executed, cause the processor to identify a unified account, determine a cash value source of the unified account, determine a non-cash value source of the unified account, and present a combined value of the cash value source and the non-cash value source. The combined value is expressed in terms of cash. Access to the unified account is provided by the apparatus through the wireless communications module.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is an example embodiment of a unified payment system (“UPS”);

FIG. 2 is an illustration of an example embodiment of a UPS showing the interaction of one or more users;

FIG. 3 is an example embodiment of the operation of a UPS application 210 on an electronic device in a UPS;

FIG. 4 is an illustration of the operation of a UPS for a user of an account to find links to additional users of a UPS to accomplish payments and payment requests.

FIG. 5 illustrates the operation of an embodiment of a UPS for sending money from a UPS account to a payee such as a UPS contact detailed in UPS contact list;

FIG. 6 illustrates the operation of an embodiment of a UPS for sending money from a UPS account to a payee that is a searchable member of a UPS;

FIG. 7 illustrates the operation of an embodiment of a UPS for sending money from a UPS account to a payee that is not a member of a UPS;

FIG. 8 illustrates the operation of an embodiment of a UPS for sending money from a UPS account to an account of payee that is configured to not be searchable in a UPS;

FIG. 9 illustrates the operation of an embodiment of a UPS for requesting money by a UPS account from an account of a potential payor such as a UPS contact detailed in UPS contact list;

FIG. 10 illustrates the operation of an embodiment of a UPS for adding a biller to a UPS account;

FIG. 11 illustrates the operation of an embodiment of a UPS for paying a biller from a UPS account;

FIGS. 12A-12E illustrate the operation of an embodiment of a UPS for conducting a point-of-sale UPS transaction;

FIG. 13 is an example embodiment of a method of accessing a UPS account;

FIG. 14 is an example embodiment of a method for sending an instant UPS payment; and

FIG. 15 is an example embodiment of a method for finding a destination UPS account for sending a payment or payment request.

### DETAILED DESCRIPTION

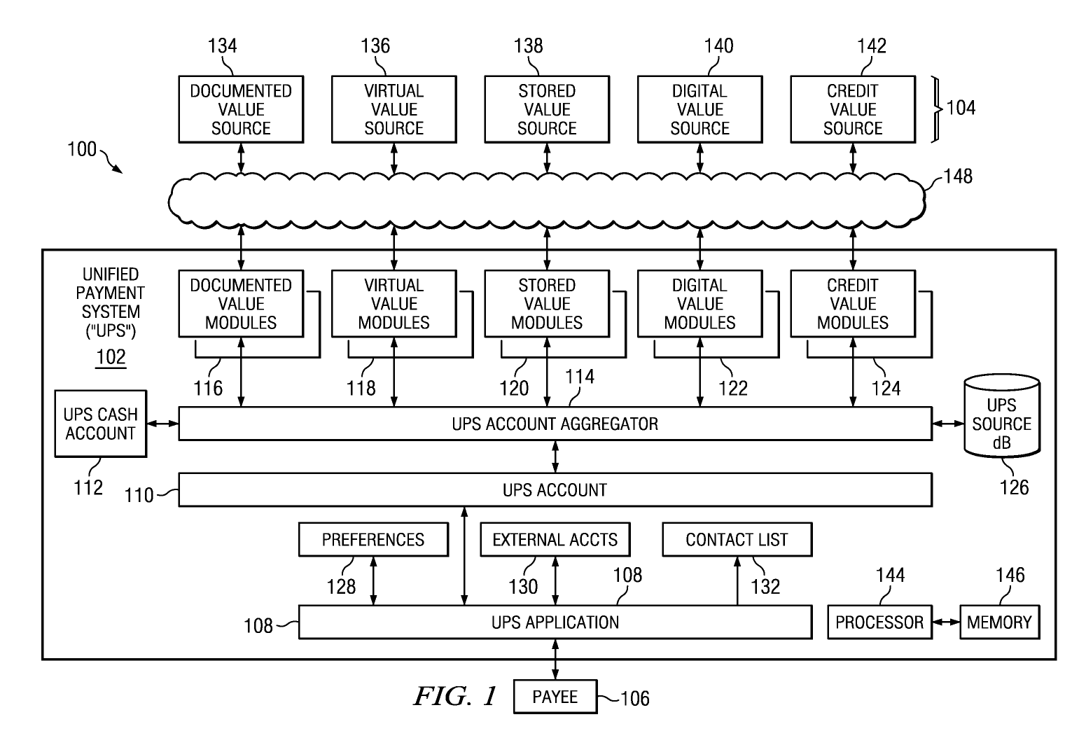

FIG. 1 is an example embodiment 100 of a unified payment system (“UPS”) 102. UPS 100 may be configured to deliver payments to a payee 106 from sources within UPS 100 and/or from external sources 104. UPS 100 may be configured to provide instant payments from a user associated with an account to a payee, wherein the payments are derived from accounts with currency and non-currency components.

UPS 100 may be configured to operate on one or more electronic devices, computers, servers, or other appropriate mechanisms. Although a single UPS 100 is shown, portions of UPS 100 may be duplicated, replicated, or otherwise be embodied or operated in different components. For example purposes, UPS 100 is shown with a single UPS application 108 and UPS account 110, though UPS 100 may include many such applications and accounts. UPS 100 may include a UPS application 108 configured to handle input and output to users, payees, other UPS systems, or other entities. UPS application 108 may reside in a memory 146 for execution by a processor 144. Although certain operations of UPS application 108 are shown, the operation of UPS application 108 may be accomplished by other portions of UPS 100, and vice-versa.

UPS 100 may include a UPS account 110, configured to be accessible by one or more UPS applications 108. UPS account 110 may be tied to a specific user. In one embodiment, UPS account 110 may be configured to be associated with an electronic device, such as a smartphone, of a specific user. UPS account 110 may be configured to be accessible from a UPS application 108 running on the same or different electronic device than UPS application 108. UPS account 110 may include an associated UPS cash account 112. In one embodiment, UPS cash account 112 may be a prepaid cash account. UPS cash account 112 may be associated with an acceptance device to access cash in the account such as a General Purpose Reloadable Account, and may have an associated debit card. UPS account 110 may include currency and non-currency value components. UPS account 110 may be configured to draw upon such components by using UPS account aggregator 114. UPS account aggregator 114 may be configured to access one or more sources of currency or non-currency value, aggregate such sources and present a unified account value to a user of UPS account 110. Such sources may reflect a disparate number and kind of sources that may be otherwise difficult to combine or employ together. A user of UPS 100 may wish to access one or more such sources together. UPS account aggregator 114 may be configured to access such sources and determine the value of each, and present the aggregate values of one or more such sources to a user of UPS 100, who may choose to make a payment to payee 106 based on a combination or selection of such sources. UPS account aggregator 114 may be configured to make such determinations, for example, upon demand from UPS application 108, upon a detected change within any of the sources, periodically, or at any other suitable time.

Payees 106 may include any suitable recipient of funds from a UPS account 110 as described herein. For example, payees 106 may include other UPS account holders, businesses with UPS accounts, utility or service companies and providers, credit card debt accounts, savings accounts, mobile payments, or retail outlets.

In one embodiment, as used herein sources 104 may also include UPS cash account 112. In another embodiment, sources 104 may be accessed for cash and deposited within UPS cash account 112. Sources 104 may include external accounts of the user of the UPS account 110. UPS account 114 may be configured to draw upon currency sources of sources 104, such as a physical value source such as UPS cash account 112, a documented value source 134 such as a checking or savings account using an ACH network, a digital value source 140 such as an online money transfer account, or a credit value source 142 such as a credit line through a credit P2P or P2 B network. UPS account 114 may be configured to draw upon non-currency sources of sources 104, such as virtual value source 136. Virtual value source 136 may include alternative forms of value that are not measured in terms of currency. For example, virtual value source 136 may include credits in an online gaming network, social network, frequent flyer program, frequent shopper program, or reward or affinity points. UPS account 114 may be configured to draw upon sources of value such as stored value source 137. Stored value source 137 may include values that may be measured in terms of currency, but are not widely considered to be tender and thus do not function as currency. Examples of stored value source 137 may include gift certificates, store- or vendor-specific account balances, accounts receivable, coupons, or other suitable sources.

In order to connect sources 104 with UPS account 114, UPS 100 may include one or more communications modules. Such communications modules may be resident in UPS 100, or may be implemented by third party services. In one embodiment, a communications module may be provided for each instance of sources 104. For example, documented value module 116 may be configured to access savings or checking accounts. A documented value module 116 may be provided for the different types of accounts at a given bank. Documented value module 116 may be configured to allow electronic transfers of money to or from documented value source 134 and UPS account 114.

Virtual value module 118 may be configured to provide conversion of virtual values in virtual value source 136 and UPS account 114. For example, given a balance of virtual values in virtual value source 136, a third party may be willing to pay a given rate of currency. Such a rate may fluctuate over time. In other example, the provider of virtual value source 136 may offer a cash-exchange option for the virtual value. In yet another example, UPS 100 may be configured to exchange values of virtual value source 136 with other users. Stored value module 120 may be configured to provide access to stored value source 138 to UPS account 114. A user of UPS 100 may wish to apply values within stored value module 120 to goods, services, locations, or vendors for which stored value module 120 may not apply. Stored value module 120 may be configured to convert of stored value source 138 into cash for use by UPS account 114. Stored value module 120 may be configured to make such conversions by, for example, exchanging stored value with the originator of stored value source 138, selling the stored value to another party, or exchanging the stored value with another user of UPS 100. The conversion rate may fluctuate over time. In one embodiment, UPS 100 may be configured to determine the applicability of stored value source 138 with a payee, merchant, or other entity for which the stored value is configured to be applied. A user of UPS 100 may have forgotten or otherwise been unaware of the ability to use stored value source 138 in a given transaction. In such an embodiment, UPS 100 may be configured to automatically select or prioritize stored value source 138 for use in sending funds to a payee, such that the value of stored value source 138 may be applied without being converted.

Digital value module 122 may be configured to provide access to a digital value source 140 for UPS account 114. Such a digital value source 140 may include funds as the result of e-commerce transactions. Credit value module 124 may be configured to provide access to credit value source 142. Credit value module 124 may be configured to access reconciliation networks for credit cards when credit value source 142 is selected as a source of funds for UPS account 114. Credit value source 142 may be configured to be represented in UPS account 114 in terms of available amount of credit.

UPS 100 may access sources 104 through network 148. Network 148 may include, for example, an intranet, the Internet, local area networks, wide-area-networks, or any suitable combination thereof.

UPS account aggregator 114 may be configured to store information about accessing various sources 104 through the various communications modules of UPS 100. Such information may include account information, login information, protocols, historical exchange rates, transaction history, or other suitable information, and may be stored in UPS source database 126.

UPS application 108 may be configured to access UPS account 110 upon request by a user of UPS 100. UPS application may be configured to update the values reflected in UPS account 110 upon such access. UPS application may access one or more preferences 118. Preferences 118 may include details about the interoperability and interoperation of UPS application 108 as shown below. Preference 118 may include ordering of funding sources 104, whereby funds from specific ones of sources 104 are applied in a designated order. A prioritization of using funds from specific sources 104 may be made on an overall source-by-source basis, made depending upon the identity of payee 106, or upon the sources of payment accepted by payee 106 (such as where payee 106 may accept particular stored value sources 138 or virtual value sources 136).

UPS application 108 may be configured to store an indication of external accounts 130. External accounts 130 may include identification of sources 104. External accounts 130 may include sources of funding UPS cash account 112 directly with a specified amount without adding such sources to sources 104 for general use by UPS account 110. External accounts 130 may include identification social media, e-mail accounts, or other sources of contact lists.

UPS application 108 may include a contact list 132 which may contain a list of users of UPS 100 or similarly configured UPSs to whom a user of UPS 100 is able to send a UPS payment. Such entities to which a payment may be made may include payee 106.

Processor 144 may comprise, for example a microprocessor, microcontroller, digital signal processor (DSP), application specific integrated circuit (ASIC), or any other digital or analog circuitry configured to interpret and/or execute program instructions and/or process data. In some embodiments, processor 144 may interpret and/or execute program instructions and/or process data stored in memory 146. Memory 146 may be configured in part or whole as application memory, system memory, or both. Memory 146 may include any system, device, or apparatus configured to hold and/or house one or more memory modules. Each memory module may include any system, device or apparatus configured to retain program instructions and/or data for a period of time (e.g., computer-readable media). The various servers, electronic devices, or other machines described below may contain one or more similar such processors or memories for storing and executing program instructions for carrying out the functionality of the associated machine.

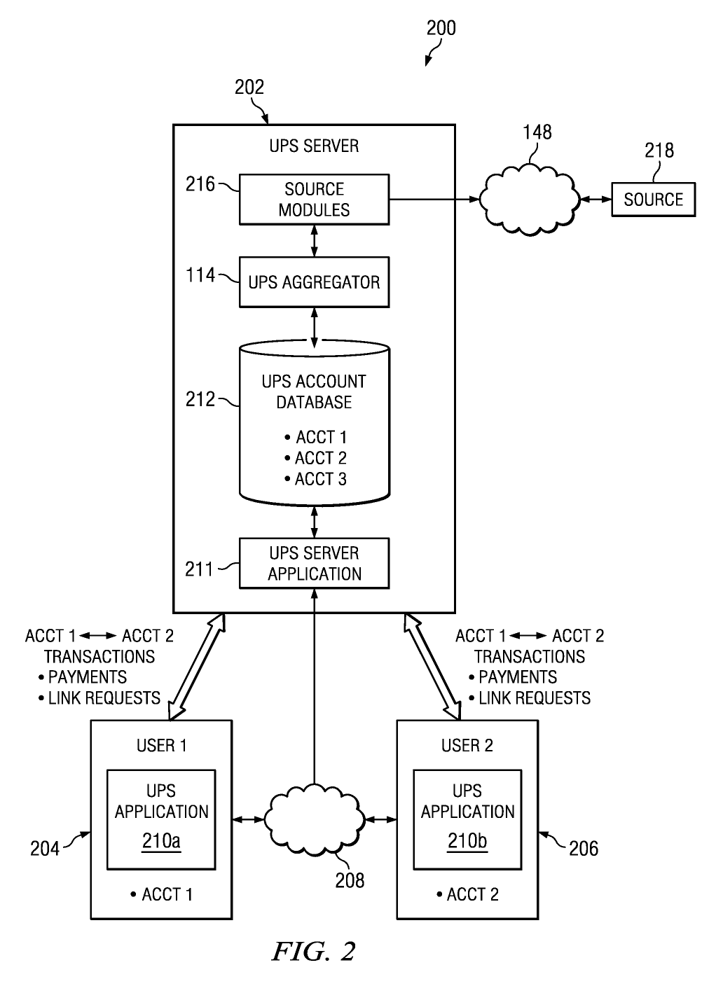

FIG. 2 is an illustration of an example embodiment of a UPS showing the interaction of one or more users. Two users, User1 and User2, using, for example, electronic devices 204, 206, may be using a UPS application 210 to send and receive payments through a UPS server 202 over a network 208. User1 and User2 may access the UPS through any suitable mechanism.

Electronic devices 204, 206 may include, for example, a terminal, cash register, computer, laptop, mobile device, tablet, or smartphone. The particular UPS application 210 operating on a given electronic device may be tailored for the computing power, typical use, or other criteria of the user or host device.

User1 may send payments to or receive payments from User2 through communication of the UPS applications 210a and 210b through UPS server 202. Such payments may be based on a UPS account such as shown in FIG. 1. User1 may be configured to make or receive link requests or link requests with User2 through UPS server 202.

UPS server 202 may embody one or more portions of UPS 100 of FIG. 1. UPS server 202 may include a processor coupled to a memory, configured to store and execute, for example, UPS server application 211. UPS server application 211 may be configured to receive, authorize, and handle requests for payment or payments received from User1 and User2. UPS server application 211 may be configured to handle link requests between User1 and User2. UPS server application 211 may be configured, for given accounts of User1 and User2, determine the values of the UPS accounts by way of UPS aggregator 114. The various accounts may be stored in a UPS account database 212. UPS account database 212 may be implemented by a record, database, or any suitable mechanism for keeping track of UPS accounts for various users. UPS server application 202 may be configured to draw funds from one UPS account in UPS account database 212, and apply the funds to another UPS account in UP account database 212 based on the requests and authorizations between User1 and User2. In drawing funds from a UPS account, UPS sever application 212 may be configured to draw values from specific sources of funding 104 or convert values from specific sources of funding 104 to cash. The resulting values or cashed may be deposited in analogous portions of the destination UPS account, such as a prepaid cash account, bank account, or virtual value source.

User1 may be configured to be associated with a particular account, such as Acct1. Acct1 may be assigned to User1 based upon, for example, User1 opening a UPS account. Acct1 may be assigned to User1 based upon an identifier provided with electronic device 204. For example, if electronic device 204 is a smartphone, it may be provisioned with an e-Wallet identification in a near-field-communication (“NFC”) chip.

User1 may be configured to make a payment request to User2, using UPS application 210a. In one embodiment, such a request may be routed through UPS server 210. In another embodiment, such a request may be routed directly to User2. User2 may be configured to accept or deny such a request. If accepting such a request, UPS application 210a may be configured to access its UPS account (Acct2) in UPS account database 212 through UPS server 202 and authorize payment to User1. UPS server application 211 may be configured to take the funds from Acct2 and place them in Acct1. The source of the funds may be determined by User2's account preferences, the nature of the demand made by User1, other criteria as described herein. User2 may be configured to allow a payment to User1 without an initial demand from User1. User2 may be configured to send payment to User1 through UPS server application 211, whereupon User1 may be configured to accept or reject the funds.

UPS application 210a of User1 may be configured to search for and establish a link to User2. Such links may be made based on a user ID, the account ID associated with the user, or other suitable mechanisms. UPS application 210a of User1 may make a request to add User2 to a link list, whereupon User1 may have certain privileges with respect to User2 such as the ability to make requests for funds or send funds to User2.

Each account of a user may be associated with one or more privacy settings by which the user may be contacted regarding payments through UPS 100. Such privacy settings may include a public setting, wherein an account for a user may be publicly searchable, and by which the user of such an account may be able to receive fund requests or payments or link requests from any user of UPS 100. For example, if User2 has an account configured to be public, User1 may be able to send money to User2, make payment requests from User2, or send link requests to User2. The privacy settings may include a private setting, wherein an account for a user may not be publicly searchable, and by which the user of an account may be able to receive fund requests, payments, and link requests only if so allowed by particular user settings. To a sender of such requests or payments, the recipient may appear to not be a user on the UPS 100. The recipient may choose to accept the request or payment, and optionally be connected to the sender, whereupon subsequent transactions may be possible.

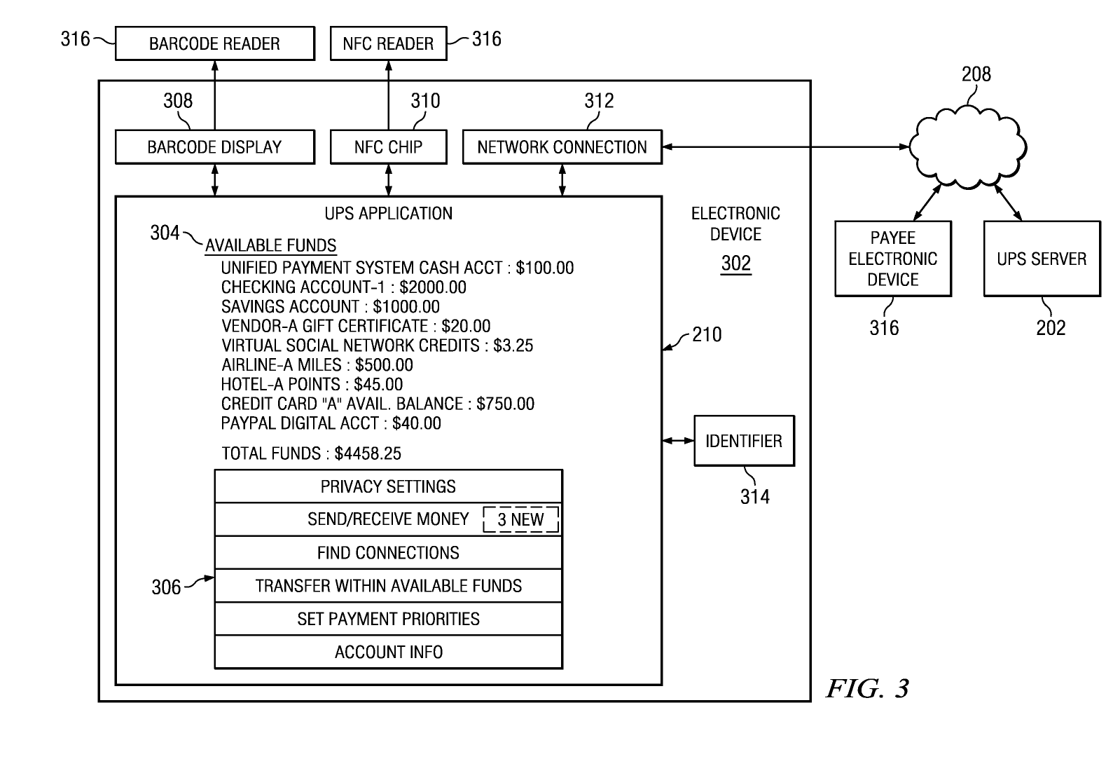

FIG. 3 is an example embodiment of the operation of a UPS application 210 on an electronic device 302 in UPS 100. Electronic device 302 may include, for example, a computer, terminal, tablet, mobile device, or smartphone. Electronic device 302 may include a processor coupled to a memory for storing and executing UPS application 210. UPS application 210 may be configured to access UPS server 202 over a network 208 through, for example, wireless mobile device telecommunications or internet protocol. UPS application 210 may be configured to access UPS server 202 for making payments, payment requests, or link requests to another account of UPS 100, such as one operating on payee electronic device 310. In one embodiment, payee electronic device 310 may be located remotely and accessible to electronic device 302 over network 208 through network connection 312. In another embodiment, payee electronic device 310 may be located locally and may be accessible to electronic device 302 by way of, for example, barcode readers or NFC communication. In such an embodiment, payee electronic device 310 may be further accessible through network connection 312.

In one embodiment, electronic device 302 may include a barcode display 308 configured to communicate information to a barcode reader 312. Such a barcode reader 312 may be located on, for example, payee electronic device 316. Barcode reader 312 and barcode display 308 may be configured to communicate using, for example, a quick response (“QR”) barcode. In another embodiment, electronic device 302 may include an NFC chip 310 configured to communicate information to an NFC chip reader 314, which may be located on, for example, payee electronic device 316. NFC chip 310 and NFC chip reader 314 may be configured to communicate information wirelessly. In various embodiments, electronic device 302 may include barcode reader 312 and NFC chip reader 314, and payee electronic device 316 may include NFC chip 310 and barcode display 308. Barcode and NFC communication may be used to provide a unique identifier to identify the electronic device and the associated UPS account. In one embodiment, the unique identifier may be based on contact information, such as phone number. If the electronic device 302 used is a smartphone, such information may be natively available for UPS application 210. In another embodiment, the unique identifier may be based on a hardware ID, such as a serial number, of the electronic device 302.

The UPS application 210 of electronic device 302 and payee electronic device 316 may be configured to communicate using I/O such as barcodes and NFCs to communicate the identity of each device, a UPS account associated with the device or user of the device, or other information to facilitate the transfer of funds in a UPS system such as UPS 100. UPS application 310 may be configured to communicate identifier 314 to payee electronic device 316 using such I/O to facilitate direct communication between UPS accounts. Identifier 314 may uniquely identify the device 302, 326, or associated UPS account. In one embodiment, electronic device 302 may be provisioned with identifier 314. Such an identifier may be configured to facilitate e-Wallet transactions. Identifier 314 may be used to create a prepaid cash account for the UPS account of FIG. 1. In one embodiment, identifier 314 may be stored in read-only memory of electronic device 302. UPS application 310 may be configured to provide identifier 311 to identify its UPS account to, for example, payee electronic device 316 through barcode display 308 or NFC chip 310. UPS application 310 may be configured to receive an identifier from another electronic device such as payee electronic device 316 through a barcode reader 312 or NFC chip reader 314. Thus, proximate electronic devices running UPS application 210 may be configured to identify their associated UPS accounts to facilitate UPS funds transfers.

In one embodiment, once identified, reconciliation or transfer of funds may be made through barcodes or NFC chips between electronic devices 302, 316. In another embodiment, once identified UPS application 210 may finish a reconciliation or transfer of funds by communicating with UPS server 202 through network connection 312. UPS server 202 may transfer funds between accounts server-side.

UPS application 210 may include information regarding available funds 304 as well as user options 306. Available funds 204 may be determined by accessing UPS server 202. Available funds 304 may be determined by accessing a UPS account 110 associated with identifier 314. The aggregated available fund 304 may be presented to a user of UPS application 210 for review. For example, the UPS account may include: a prepaid cash balance of $100, a checking account balance of $2000, a savings account balance of $1000, a gift certificate from “Vendor-A” in the amount of $20, an account of virtual credits from a social network with a converted value of $3.25, frequent flyer airlines miles from “Airline-A” with a converted cash value of $500, a hotel rewards program from “Hotel-A” with a converted cash value of $45, an available credit line from “Credit Card-A” of $750, and a PayPal digital account with a balance of $40. The total funds available to the UPS account may thus be $4458.25. Each element of available funds 304 may be selectable. UPS application 210 may be configured to display additional information regarding the source, history, conversion rate, or other data of the source of funds of the element.

In one embodiment, to fund a given transaction UPS application 210 may be configured to request that UPS server 202 convert and transfer the funds from the source first into the prepaid cash account before sending the cash to another UPS account. In another embodiment, UPS application 210 may be configured to send a request that UPS server 202 make a transfer of the type and kind of value in the source to another UPS account directly. For example, a gift certificate for “Vendor-A” may be applied to a transaction at Vendor-A, or may be transferred to another UPS account with a user who can use the gift certificate more easily than the previous owner. Such a user may accept the gift certificate as a payment.

User options 306 may include any suitable operations to be taken by a user of UPS application 210. For example, user options 306 may include options to change the privacy settings. User options 306 may include options to initiate sending or receiving money. If any pending requests or payments from other users have been received, an indication of such pending requests or payments may be made. User options 306 may include options for finding other users of UPS 100 to whom payments and payment requests may be made. User options 306 may include options for moving funds within the sources of value for the UPS account. For example, affinity points may be immediately cashed in into the prepaid cash account. User options 306 may include an option to change the funding or payment priority settings. User options 306 may include an option to see or change account information.

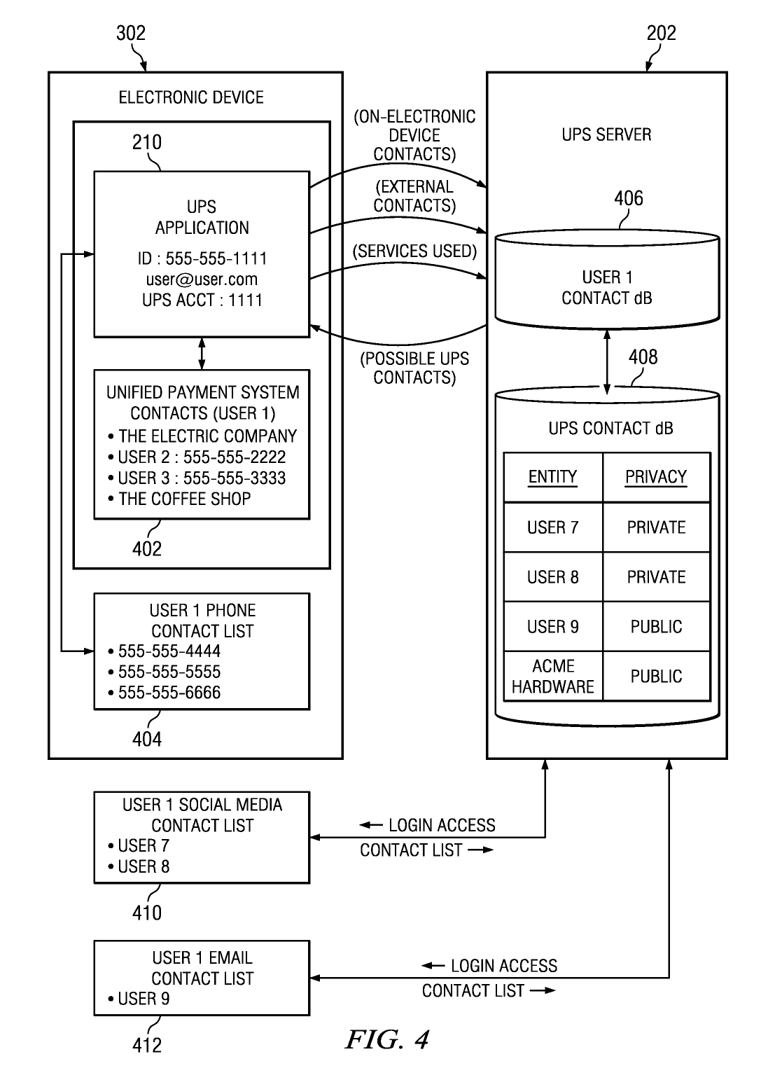

FIG. 4 is an illustration of the operation of UPS 100 for a user of an account to find links to additional users of UPS 100 to accomplish payments and payment requests. UPS application 210 may contain indicia of the associated UPS account. In one embodiment, the phone number of a user may be used as the basis for the UPS account. The identifier of FIG. 3 may include the phone number of the user or the phone number of the electronic device 302. Phone numbers and phone number contact lists may be readily accessible to electronic device 302, along with I/O devices such as barcode and NFC communication devices. In other embodiments, e-mail addresses or UPS account numbers may be used.

UPS application 210 may be configured to access a contact list of UPS contacts. Such a contact list may include users or accounts for which UPS application 210 has established a link. The contact list may be implemented in, for example, UPS contacts 402 resident on the electronic device 302 or in User1 contact database 406 on UPS server 202. For example, UPS contacts 402 may include entries for “The Electric Company,” User2 of 555-555-2222, User3 of 555-555-3333, or “The Coffee Shop.” When initiating a payment or request for payment, UPS application 210 may be configured to access, for example, UPS contacts 402 to present destination options to a user. Further, if a destination of payments or payment requests is manually entered, UPS application 210 may be configured to search UPS contacts 402 for a match. For example, if a user entered into UPS application 210 that a payment was to be sent to 555-555-9999, UPS application 210 may be configured to determine whether the phone number is associated with an existing linked account. If not, UPS application 210 may be configured to submit the destination account to server 202 for authorization.

UPS contacts 402 may include entries such as User2 of 555-555-2222 that are indexed upon the phone number of the other user. UPS contacts 402 may also include contacts for billers, such as “The Electric Company” or vendors such as “The Coffee Shop.” Such billers or vendors may be indexed by name or other indications other than phone number. Such indexing may be possible due to the volume of the operation of such billers or vendors, the decreased need for privacy, or decreased chances of confusion.

UPS contacts 402 may be established by sending a link request to UPS server 402, or making a local access such as one accomplished through a barcode or NFC chip information exchange. For example, two users with smartphones may use an NFC chip to exchange UPS account information for future UPS payments. In another example, a user with a smartphone may read a QR code from a local merchant and store the contact for future UPS payments.

UPS application 210 may be configured to access UPS server 402 to find additional contacts to add to UPS contacts 402 and/or make a payment or payment request. In one embodiment, potential payors or payees must first be added as a contact in UPS contacts 402. In another embodiment, a specific payor or payee may be searched for through UPS server 402.

To find new contacts, UPS application 210 may be configured to access UPS server 202. UPS server 202 may include information regarding all of the accounts and users available in UPS 100. UPS server 202 may store such information in UPS contact database 408. UPS contact database 408 may be implemented in any suitable record, file, server, database, or other suitable mechanism. UPS contact database 408 may include a listing of various entities, such as users, vendors, or billers, and an associated privacy setting. Such a privacy setting, as described above, may determine whether or not the entity can be found in a search sent to UPS server 202. For example, User7, User8, and Acme Hardware may be configured to be searchable by queries to UPS server 202. In contrast, User9 may be configured as private, wherein its listing and participation in UPS 100 may not be obtained through a search sent to UPS server 202.

To find new contacts, UPS application 210 may submit a list of contacts known to UPS application 210. Such known contacts may include a list of contacts resident on electronic device, such as phone contact list 404. Such a phone contact list 404 may include the contacts used normally in the use of electronic device 302. In FIG. 4, for example, the phone contact list 404 may include entries for 555-555-4444, 555-555-5555, and 555-555-6666. UPS application 210 may also submit contacts from outside UPS application 210, such as contacts from a social media contact list 410 or an e-mail contact list 412. UPS application 210 may submit such contact lists directly to UPS server 202, or UPS server 202 may access such entities on behalf of UPS application 210.

UPS server 202 may be configured to compare submitted contact lists against UPS contact database 408 and determine any common entries. UPS server 202 may be configured to eliminate any common entries for which a privacy setting indicates that the entry should not be shared with UPS application 210. For example, a UPS account may be set to private. UPS application 210 may be configured to provide the list of possible contacts to UPS application 210. A user of UPS application 210 may be able to select from the possible new contacts, or may receive notification that a particular searched-for account was found. In the example of FIG. 4, entries for User7 and User8 may be presented to a user of UPS application 210, but not an entry for User9.

In operation, a UPS application 210 may access a UPS account 110 from a UPS server 202. UPS account 110 may be updated by a UPS account aggregator 114, which may use various communications modules to obtain indications of values from a disparate number and kind of value sources 104. Such value may be transferable to another UPS account, or to a prepaid UPS cash account 112 associated with the UPS account. Prepaid UPS cash account 112 may also be accessed by, for example, debit or credit cards issued on the prepaid UPS cash account 112.

A UPS application 210 may send or receive payments based on a UPS account 110 to other entities operating another UPS application 210 in conjunction with another UPS account 110 of UPS 100. The UPS application 210 may send or receive link connection requests to other UPS accounts to facilitate UPS transactions. UPS application 210 may discover possible UPS contacts for an account by submitting other contact lists, such a phone number contacts, to a UPS server 202.

A UPS account 110 may be broadcast to other users of UPS 100 according to one or more privacy settings associated with UPS account 110. UPS account 110 may be configured to allow users to register themselves using, for example, a phone number or other contact information by which their account may be discovered in UPS 100. Thus, UPS account 110 may be configured to be pushed or pulled for payments regardless of the underlying funding sources of UPS account 110. If UPS account 110 is configured to be private, then another user of UPS 100 may not be able to successfully find UPS account 110 in a search. From the sender's perspective, the ability to contact the UPS account may be limited to, for example, sending a pickup message to someone without a UPS account 110. Even this kind of limited message may require manually entering the phone number or e-mail address of the UPS account 110. The user attempting to send funds to UPS account 110 in such a situation may be, for example, sending funds hoping to encourage the user of UPS account 110 to connect to UPS 100, sending funds after the owner of UPS account 110 has advised the sender of a phone number or e-mail address by which funds may be send over UPS 100.

If UPS account 110 is configured to be public, the existence of UPS account 110 may be broadcast to other users of UPS 100 and may be able to receive payments and payment requests. In one embodiment, a UPS account 110 of a biller or vendor may be accessible through setting location information—wherein, for example, a user standing in a place of business may easily add the UPS account 110 of the business to make a payment—or listing the UPS account 110 in a browsable or searchable business directory.

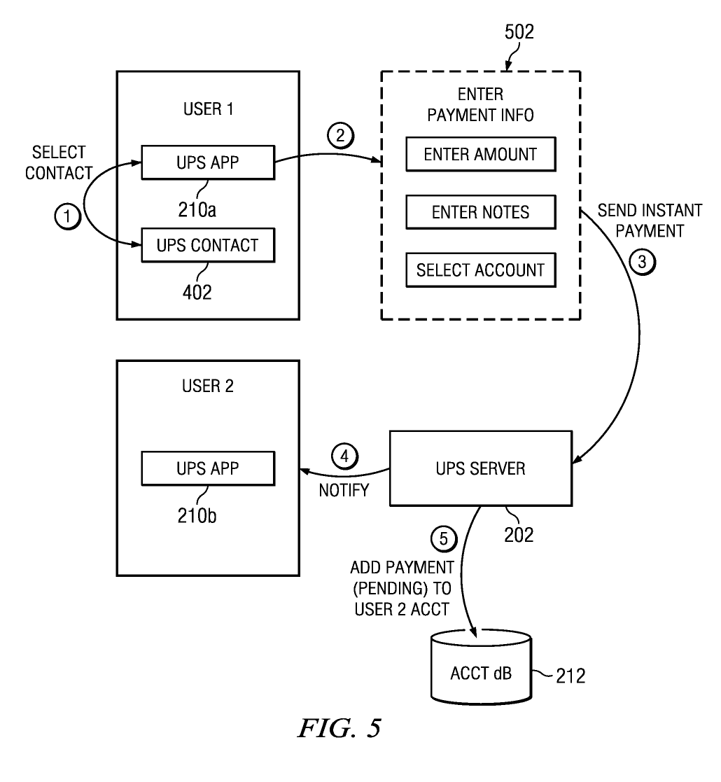

FIG. 5 illustrates the operation of an embodiment of UPS 100 for sending money from a UPS account 110 to a payee 106 such as a UPS contact detailed in UPS contact list 402. User1 may be sending funds using UPS application 210a from a variety of sources from within UPS account 110 to User2 via UPS server 202.

At (1), User1 may use UPS application 210a to select a contact from UPS contact list 402 to send a payment. If such a contact is not found, a process for searching for a contact may be conducted. At (2), UPS application 210a may produce an enter payment information screen 502. Such a screen 502 may prompt the user to enter an amount to be paid, enter notes regarding the payment, or select an account from which the payment may be made. UPS application 210a may detect the destination of the payment, determine methods of accepted payments, and compare the methods of payment accepted with sources 104 of funding. UPS application 210a may make recommended payment options based on such a comparison. For example, if the destination of the payment is a particular vendor and sources 104 of funding include a value for which conversion to cash is not necessary—such as stored value source 138 like a gift certificate or coupon for the particular vendor, or a virtual value source 136 such as airline miles redeemable by the particular vendor for a particular purchase—UPS application 210a may recommend such a payment source 104. In another example, a payee 106 such as another user may accept a virtual value source 136 such as gaming credits of affinity reward points accept particular gift cards such as one stored in stored value source 138. UPS application 210a may determine such methods of accepted payments by querying the account in UPS account database 212, wherein such payees may define methods of payment accepted. At (3), UPS application 210a may send an instant payment from the associated account 110 to another account in UPS 100. Such an instant payment may be made to and processed by UPS server 202. UPS server 202 may use sources of funding 104 according to prioritization settings defined by the account or by the particular transaction request. At (4), UPS server 202 may notify a user, such as User2, of the destination UPS account via UPS application 210b that a payment is ready to be accepted. At (5), the payment may be added to the UPS account of User2 in UPS account database 212. Such a payment may be designated as pending until it is accepted.

The process of finding new contacts may be conducted, for example, upon a search or attempted payment initiated by a user of UPS application 210, periodically, at start-up, or any other suitable time. For example, a check for new users may be performed at startup of UPS application 210, whereupon potential new matches may be presented to the user of UPS application 210.

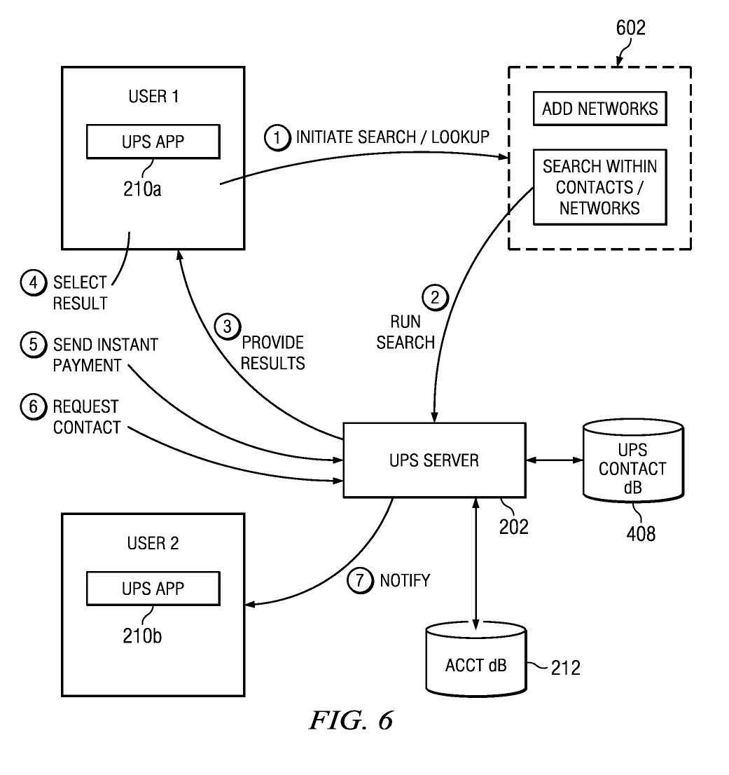

FIG. 6 illustrates the operation of an embodiment of UPS 100 for sending money from a UPS account 110 to a payee 106 that is a searchable member of UPS 100. User1 may be sending funds using UPS application 210a from a variety of sources from within UPS account 110 to User2 via UPS server 202. User2 may not yet be a contact with an established link to User1. User2 may have established a UPS account and provided contact information such as a phone number by which other users of UPS 100 may find User2's account and send payments or payment requests.

At (1), UPS application 210a may initiate a search for an account of User2 to send a payment. UPS application 210a may have already searched its own UPS contact list and not found a link for the UPS account of User2. To conduct such a search or lookup, UPS application 210a may present a screen 602 for accepting user input to search the UPS 100 for an entered phone number or other identifying information within, for example, the phone contacts associated with a smartphone running UPS application 210a. UPS application 210a may also present options to add additional contact lists or networks which may be searched for UPS users. At (2), the contact lists provided by UPS application 210a may be compared by UPS server 202 against the registered users of UPS 100 in UPS contact database 408. Users whose accounts have been configured to be searchable and are present in UPS contact database may be found. At (3), UPS server 202 may present search or lookup results to UPS application 210a. Such results may include, for example, a specific account that was searched, or all possible accounts that were associated with contacts of User1. The results may include accounts for which a connection is already made or for which a connection may be made. The results may indicate contacts for which no UPS account exists (or is hidden), to which an invitation to join UPS 100 may be sent. At (4), one of the results may be selected by UPS application 210a, such as an account associated with User2, who may be using an electronic device operating UPS application 210b. At (5), an instant payment may be sent from UPS application 210a to the selected payee 106. Such a process may be substantially conducted by the operation as shown in FIG. 5. At (6), UPS application 210a may send a link request to the selected account to add the selected account to the UPS connect list of User1. At (7), UPS application 210b may be notified of a pending payment added to UPS account database 212. UPS application 210b may present options to User2 to accept the payment and/or add the account of User1 to User2's UPS contact list.

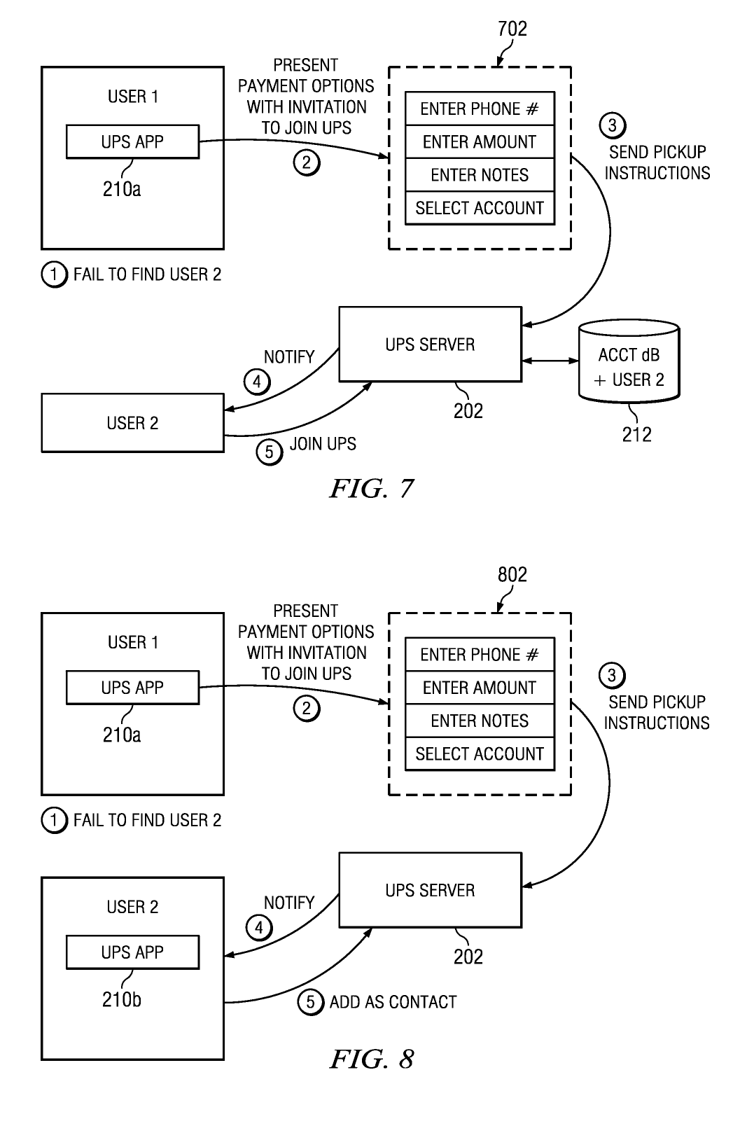

FIG. 7 illustrates the operation of an embodiment of UPS 100 for sending money from a UPS account 110 to a payee 106 that is not a member of UPS 100. User1 may be sending funds using UPS application 210a from a variety of sources from within UPS account 110 to User2 via UPS server 202. User2 may not yet have a UPS account within UPS 100. User2 may have an identifying phone number, e-mail address, or other information by which User2 may be contacted electronically or by mail that a payment is available in UPS 100.

At (1), UPS application 210a may fail to find a UPS account for User2 to send a payment. Such a failure may come after conducting the searches illustrated in FIG. 6. At (2), UPS application 210a may present payment options for a payment or pending payment with an invitation to join UPS 100 to be sent to User2. UPS application 210a may present a pay option to User1, who may select to send a payment to User2 despite the absence of a UPS account. UPS application 210a may present a payment screen 702 with options to enter a phone number or other contact information, an amount to be paid, other notes regarding the transaction, and a funding source option. At (3), UPS application may send the pickup instructions to UPS server 202, which at (4) may notify User2 regarding the pending payment. Notification may be conducted through any suitable process, such as mailing a letter to User2, sending a text message, e-mail, or social network message. Such notification may depend upon the method of contact provided by UPS application 210a at (2). User2 may select to join UPS 100 to pick up the pending payment. UPS server 202 may add an account for User2 to UPS account database 212.

Some steps of FIG. 7 may be conducted to invite additional entities or uses to join UPS 100 without sending a payment. For example, UPS application 210a may include an option to invite additional users, prompting a user to select contact information, and sending the requests to UPS server 202, which may send invitations to, for example, User2.

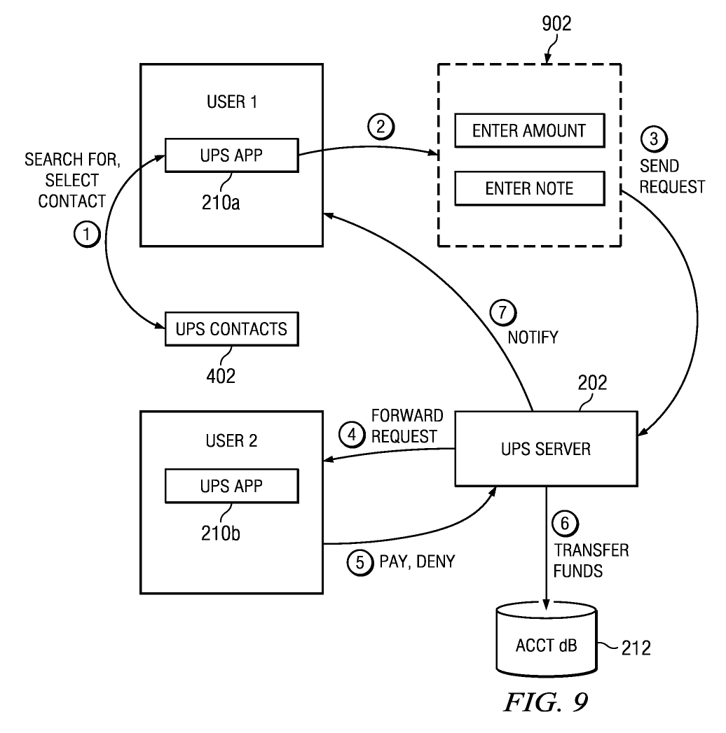

FIG. 8 illustrates the operation of an embodiment of UPS 100 for sending money from a UPS account 110 to an account of payee 106 that is configured—for example, by privacy settings—to not be searchable in UPS 100. For example, an account of User2 may be configured to be private. User 1 may be sending funds using UPS application 210a from a variety of sources from within UPS account 110 to User2 via UPS server 202. User2 may have a UPS account within UPS 100 with an identifying phone number, e-mail address, or other information.

At (1), UPS application 210a may fail to find a UPS account for User2 to send a payment. Such a failure may come after conducting the searches illustrated in FIG. 6. At (2), UPS application 210a may present payment options for a payment or pending payment with an invitation to join UPS 100 to be sent to User2. Such options may be similar to the options shown in FIG. 7. Thus, from the perspective of UPS application 210a and User1, the situations encountered in

FIG. 7 and FIG. 8 may be the same. UPS application 210a may present a pay option to User1, who may select to send a payment to User2 despite the perceived absence of a UPS account. UPS application 210a may present a payment screen 802 with options to enter a phone number or other contact information, an amount to be paid, other notes regarding the transaction, and a funding source option. At (3), UPS application may send the pickup instructions to UPS server 202. At (4), UPS server 202 may look up the UPS account for User2 based on the contact information provided by UPS application 210a, and notify UPS application 210b and User2 that a payment is pending. User2, through UPS application 210b, may select to accept the payment privately, wherein UPS application 210b and User1 are not notified that acceptance of the funds was made using a UPS account. User2, through UPS application 210b, may select to accept the payment and add the account of User1 as a UPS contact, thus notifying User1 that an account exists for User2. Subsequent transactions may be conducted between the accounts for User1 and User2 by normal payment mechanisms between contacts as illustrated in FIG. 5.

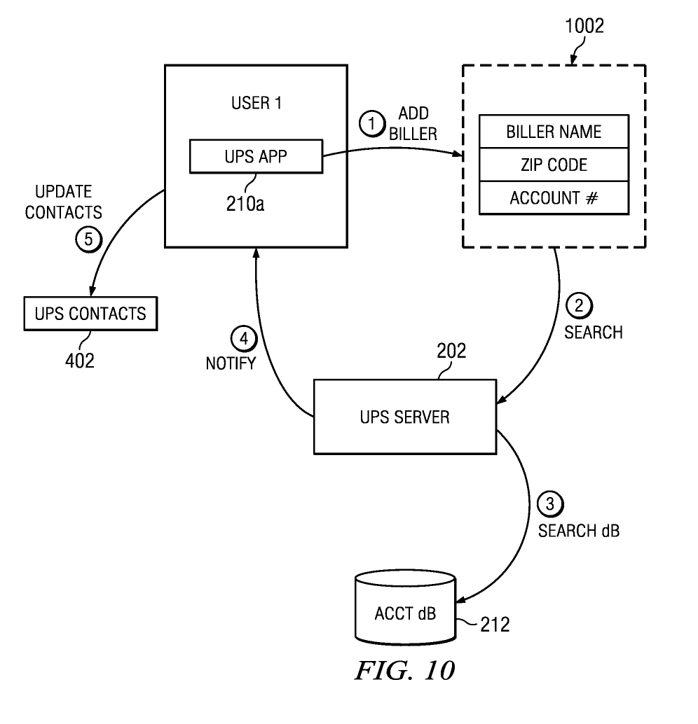

FIG. 9 illustrates the operation of an embodiment of UPS 100 for requesting money by a UPS account 110 from an account of a potential payor such as a UPS contact detailed in UPS contact list 402. User1 may be requesting funds using UPS application 210a from, for example User2, who may respond to the request with a payment from a variety of sources within a UPS account. Such requests and payments may be handled via UPS server 202. Although FIGS. 5-9 are shown as sending payments, each may be modified to send a payment request. Such a payment request may be accepted or rejected by the recipient as shown below at (4) and (5).

At (1), User1 may use UPS application 210a to select a contact from UPS contact list 402 to send a request for a payment. If such a contact is not found, a process for searching for a contact may be conducted. Such a search may be conducted with analogous steps substantially similar to those illustrated in FIG. 6 modified to request funds instead of send funds. If the search fails, a payment request may be sent to a non-member or a private member with analogous steps substantially similar to those illustrated in FIGS. 7 and 8 modified to request funds instead of send funds. At (2), UPS application 210a may produce an enter payment request screen 902. Such a screen 902 may prompt the user to enter an amount to be requested and enter notes regarding the payment. At (3), UPS application 210a may send an instant payment request from the associated account 110 to another account in UPS 100. Such an instant payment may be made to and processed by UPS server 202. At (4), UPS server 202 may notify a user, such as User2, of the destination UPS account via UPS application 210b that a payment has been requested. At (5), the payment request may be accepted or rejected. Such a payment request may be accepted by sending a payment with selected funding options for transferring funds in UPS account database 212 from the UPS account of User2 to the UPS account of User1. At (6), UPS server 202 may transfer the funds between the accounts and otherwise notify User1.

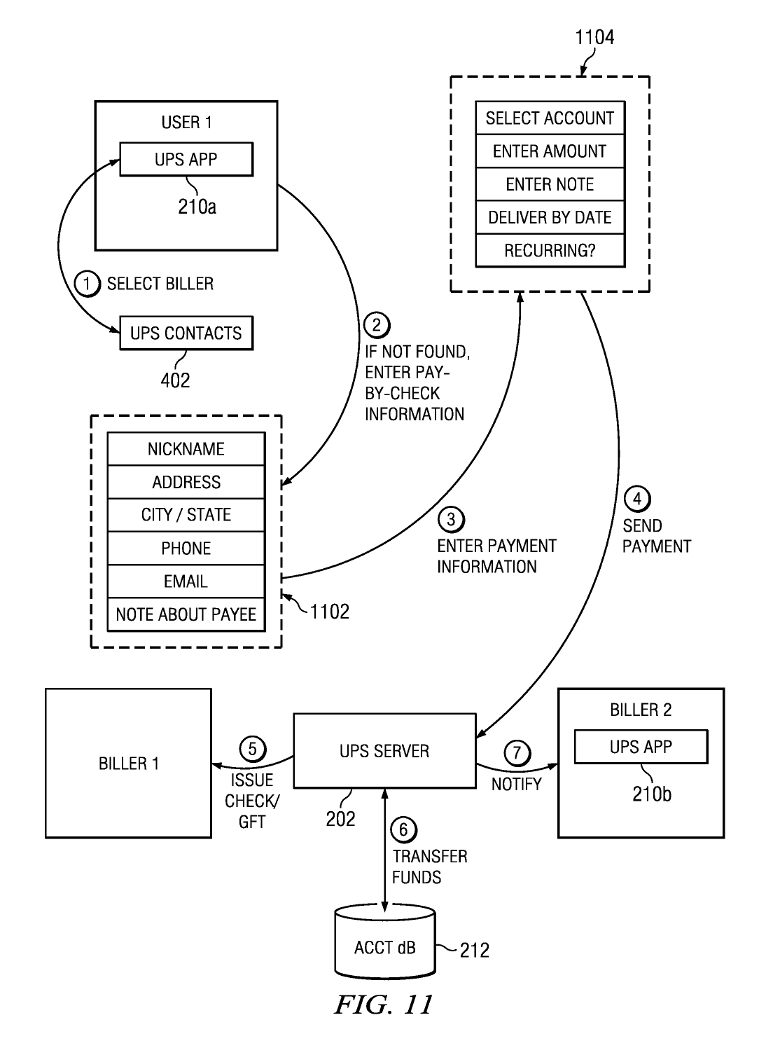

FIG. 10 illustrates the operation of an embodiment of UPS 100 for adding a biller to a UPS account 110. A biller may be a contact with particular requirements for receiving UPS fund transfers such as an account number. In one embodiment, billers may typically have public registration in UPS 100.

At (1), UPS application 210a may present options to User1 for adding a biller. In one embodiment, such a biller may be found by browsing listings of billers by, for example, location or service type. In another embodiment, UPS application may present a biller search screen 1002 for finding a biller. The screen 1002 may include options for searching for the biller name. Options for searching for a location by way of zip code may be presented. An option for entering an account number corresponding to the user's account with the biller may be presented. Such an option may be entered at the beginning of the search or upon adding the biller to a contact list. At (2), UPS application 210a may send the search parameters to UPS server 202, which at (3) may search UPS account database 212 for any such billers. At (4), UPS server 202 may notify UPS application 210a of any search results. At (5), UPS application 210a may select one of the search results and add the contact to UPS contacts 402. In one embodiment, the biller may be configured with public privacy settings, such that biller may allow payments from any users with accounts with the biller.

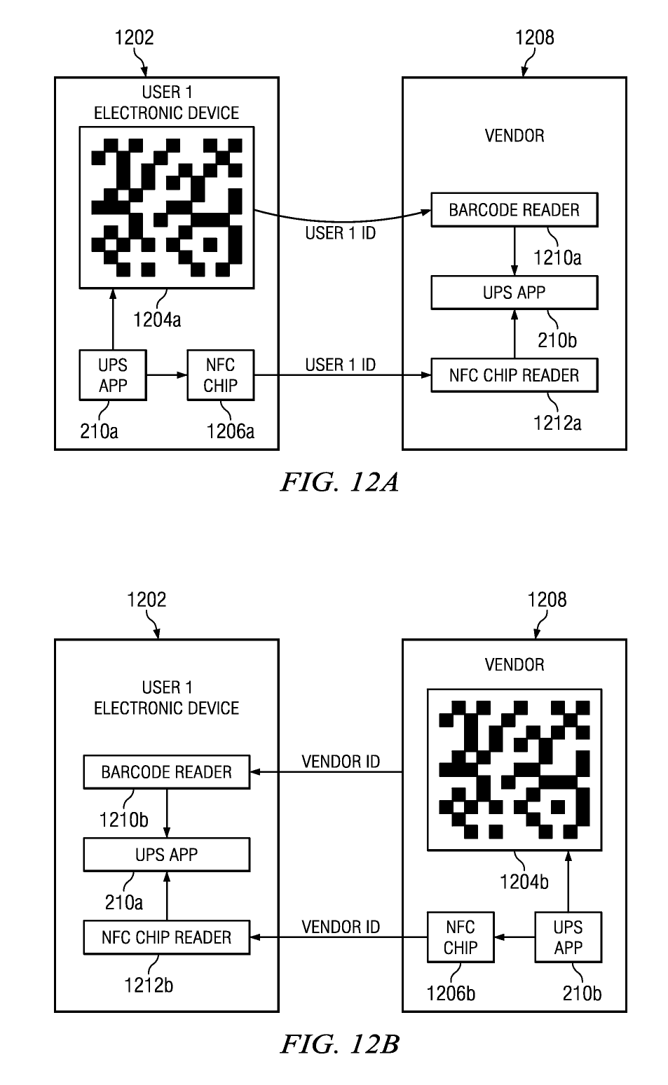

FIG. 11 illustrates the operation of an embodiment of UPS 100 for paying a biller from a UPS account 110. User1 may be sending funds using UPS application 210a from a variety of sources from within UPS account 110 to Biller1 or Biller2 via UPS server 202. Biller2 may have a UPS account and may sent a request for payment to User1 using the steps of FIG. 9. User1 may have added Biller2 to UPS contacts 402 using the steps of FIG. 10. Biller1 may be a biller without a UPS account.

At (1), a biller to be sent payment may be selected from UPS contacts 402. At (2), if such a biller is not found, UPS application 210a may present a pay-by-check option screen 1102. Screen 1102 may contain options for information to be used by UPS 100 to issue a check to a biller such as Biller1 because the biller does not have a UPS account. Screen 1102 may present options for remembering a biller by nickname, entering the biller's address, city, state, phone, e-mail, and notes about the check. At (3), UPS application 210a may present a payment options screen 1104. Screen 1104 may be presented for payments to billers with or without UPS accounts. Screen 1104 may contain options for entering an amount to be paid, a note regarding the payment, a deliver-by date, an option for a recurring payment, and options to select a source of funding. At (4), an instant payment or pay-by-check request is sent to UPS server 202. At (5), if the biller such as Biller1 does not have an account in UPS account database 212 and if so requested by UPS application 210a, UPS server 202 may issue a check to Biller1. Such a check may be a physical check or an electronic funds transfer. At (6), if the biller such as Biller2 has an account in UPS account database 212, UPS server 202 may transfer funds from the user's UPS account to the Biller2's UPS account. At (7), Biller2 may be notified via UPS application 210b that a payment is available to be accepted.

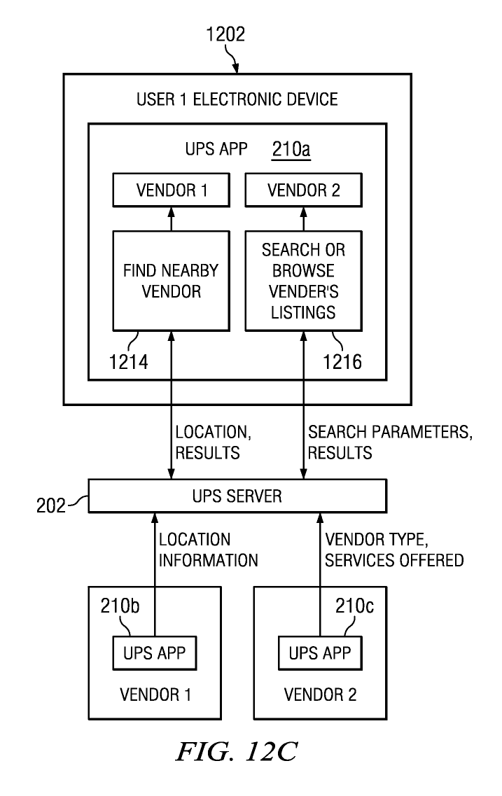

FIGS. 12A-12E illustrate the operation of an embodiment of UPS 100 for conducting a point-of-sale UPS transaction. User1 may include electronic device 1202 which may be executing UPS application 210a to conduct a point-of-sale UPS transaction with Vendor, which may include electronic device 1208 which may be executing UPS application 210b to conduct the transaction.

FIG. 12A is an illustration of an embodiment of UPS 100 where a user's electronic device 1202 is contacting vendor's electronic device 1208 to provide an identifier or other identifying information of the user. Such an identifier may include an indication of a UPS account, such as an account number. In one embodiment, electronic device 1202 may contain a barcode display 1204a for displaying an identifier embedded within a barcode such as a QR code. Such an identifier may be provided by UPS application 210a. Electronic device 1208 may contain a barcode reader for reading the barcode, which may be interpreted by UPS application 210b to determine the identifier. In another embodiment, electronic device 1202 may include an NFC chip 1206a for providing information including the identifier. Electronic device 1208 may include a an NFC chip reader 1212a for reading information from NFC chip 1206a, which may be interpreted by UPS application 210b to determine the identifier.

To initiate a transaction, User1 may present electronic device 1202 to Vendor in such a way to transmit the identifier to Vendor's UPS application 210b. After providing such an identifier, UPS application 210b may be aware of which UPS account to charge a sale of goods or services. UPS application 210b may contact a UPS server with a request for payment. The UPS server may query the user UPS application 210a for confirmation. User may be presented with the conformation request by UPS application 210a, and may confirm the transaction to complete the sale. The UPS server may transfer value or funds from the user's UPS account to a UPS account for the vendor.

FIG. 12B is an illustration of an embodiment of UPS 100 where user's electronic device 1202 is contacting vendor's electronic device 1208 to receive an identifier or other identifying information of the vendor. Such an identifier may include an indication of a UPS account, such as an account number. In one embodiment, electronic device 1208 may contain a barcode display 1204b for displaying an identifier embedded within a barcode such as a QR code. Such an identifier may be provided by UPS application 210b. Electronic device 1202 may contain a barcode reader for reading the barcode, which may be interpreted by UPS application 210a to determine the identifier. In another embodiment, electronic device 1208 may include an NFC chip 1206b for providing information including the identifier. Electronic device 1202 may include a an NFC chip reader 1212b for reading information from NFC chip 1206b, which may be interpreted by UPS application 210a to determine the identifier.

To initiate a transaction, User1 may present electronic device 1202 to Vendor in such a way to receive the identifier to Vendor's UPS application 210b. In one embodiment, a barcode such as a QR code for the vendor may be displayed at, for example, a checkout register. In such an embodiment, the QR code may be printed and displayed, and thus not require active display from electronic device 1208. After receiving such an identifier, UPS application 210a may be aware of which UPS account to send money regarding a sale of goods or services. UPS application 210a may contact a UPS server with a payment to be sent to Vendor. The payment may be in an amount presently due to Vendor. The UPS server may query the user UPS application 210b for confirmation. The UPS server may transfer value or funds from the user's UPS account to a UPS account for the vendor.

FIG. 12B is an illustration of an embodiment of UPS 100 where user's electronic device 1202 searches for a vendor's UPS account to add vendor as a contact. Electronic device 1202 may be operating UPS application 210a, which may present options to find a nearby vendor 1214 or search/browse for vendor listings 1246. User1, Vendor1, and Vendor2 may have UPS accounts registered with UPS 100.

Vendor1 may include an electronic device operating UPS application 210b, which may contact UPS server 202 to provide information regarding the location of Vendor1. Such a location may be given in map coordinates, address, GPS location, or other suitable identifying information. Vendor2 may include an electronic device operating UPS application 210c, which may contact UPS server 202 to provide information regarding the type of vendor, specific goods or services offered, payment options accepted, or other information regarding the business operations of Vendor2. UPS server 202 may be configured to store such information regarding Vendor1 and Vendor2 in an account database.

UPS application 210a, upon selection of an option to find nearby vendors, may transmit such a request to UPS server 202. UPS application 210a may include information regarding the location, address, GPS location, map coordinates of electronic device 210a or a designated search location to UPS server 202. UPS server 202 may search the UPS account database for matching vendors. UPS server 202 may determine that Vendor1 is located in the same location as electronic device 1202, and send the results back to UPS application 210a. UPS application 210a may display the results to User1, who may select Vendor1 to send a payment.

UPS application 210a, upon selection of an option to search or browse vendors, may transmit such a request to UPS server 202. UPS server 202 may transmit search or browsing options back to UPS application 210a, such as types of vendors, services, or payment options. User1 may select such choices from UPS application 210a and send the search parameters to UPS server 202. UPS server 202 may search the UPS account database for matching vendors. UPS server 202 may determine that Vendor2 matches the search criteria provided, and send the results back to UPS application 210a. UPS application 210a may display the results to User1, who may select Vendor2 to send a payment.

FIG. 12D is an illustration of an embodiment of UPS 100 of a UPS point-of-sale transaction wherein a vendor provides a UPS account identification to a user. At (1), a vendor may determine an amount owed for a good or service. At (2), the UPS account identifier of the vendor may be transmitted to the user's UPS application 210a by the vendor's UPS application 210b. Such a transfer of identification may be accomplished by one or more of the methods described in FIGS. 12A-12C, in combination with FIGS. 5-11. In combination, a request for payment may be sent from Vendor's UPS account to User1's UPS account. However, such a request may require UPS application 210b to discover the account of User1. Such discovery may be accomplished by, for example, the operation of FIG. 12A. At (3), UPS application 210a may send a payment to the UPS account of Vendor using, for example, the operation of FIG. 5. In one embodiment, UPS application 210a may simplify such a funds transfer process by presenting a screen 1218 giving options to enter an amount and select an account from which to draw funds. At (4), a confirmation or receipt may be send to User1 through UPS application 210a.

FIG. 12E is an illustration of an embodiment of UPS 100 of a UPS point-of-sale transaction wherein a user provides a UPS account identification to a vendor. FIG. 12E may operate substantially similar to FIG. 12D. However, at (2) the UPS account identifier of the user may be transmitted to the vendor's UPS application 210b by the user's UPS application 210a. Such a transfer of identification may be accomplished by one or more of the methods described in FIGS. 12A-12C, in combination with FIGS. 5-11. In combination, a payment may be sent from User1's UPS account to Vendor's UPS account. To conduct such a payment, User1's UPS application 210a must be aware of the account of Vendor, or Vendor must issue a payment request to User1. Such operations may be accomplished by, for example, the operation of FIG. 12B or FIG. 6.

In various embodiments, the operation of FIGS. 12D and 12E may be combined wherein the UPS applications 210 of User1 and Vendor may exchange account identifiers. Such an exchange may be accomplished by, for example, the operation of FIGS. 12A-12C. In such embodiments, UPS application 210a and/or UPS application 210b may initiate payment or request for payment for the amount owed.

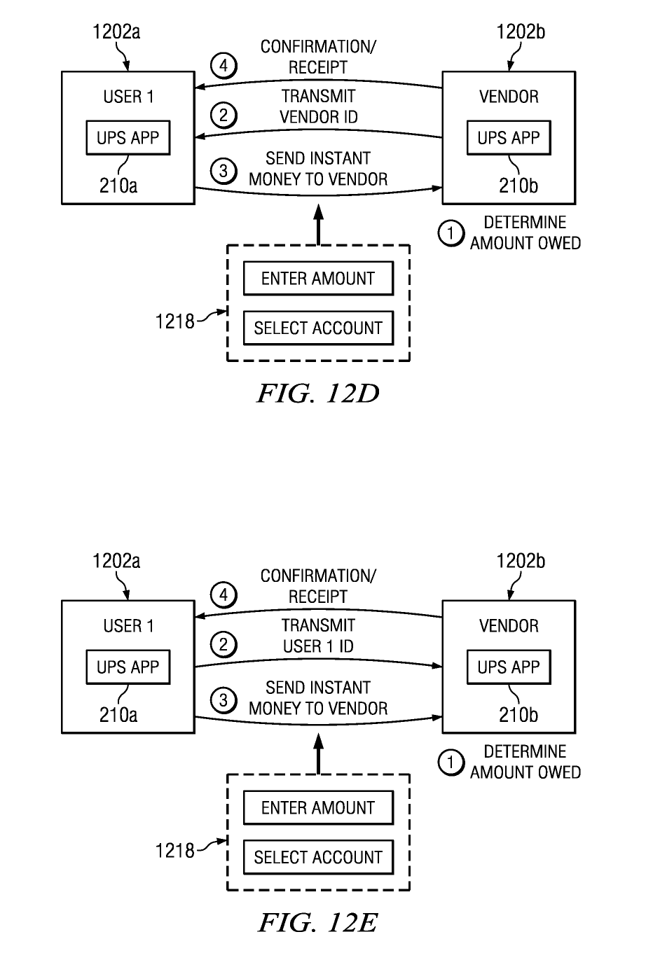

FIG. 13 is an example embodiment of a method 1300 of accessing a UPS account. In step 1305, a prepaid cash account associated with the UPS account may be accessed. The cash value may be determined. In step 1310, a documented value source such as a checking or savings account may be accessed. The cash value may be determined. In step 1315, a virtual value source such as an affinity program or points in a gaming program may be accessed. In step 1320, the cash value of such virtual value source may be determined. Such a cash value may be determined by accessing services configured to quote, buy, or sell such virtual values, or by receiving bids from a potential buyer of such values. In step 1325, a digital value source such as an e-commerce account may be accessed and the cash value determined. In step 1330, a stored value source may be accessed. In step 1335, the cash value of such a stored value source may be determined. Such a cash value may be determined by accessing services configured to quote, buy, or sell such stored values, or by receiving bids from a potential buyer of such values. Steps 1305-1335 may be conducted by accessing external networks for each such account. Services may be provided for accessing, transferring ownership, depositing, or withdrawing value from such accounts.

In step 1340, the aggregate cash value of the value sources may be determined. The value may be made available to a user when evaluating purchases, payments, or other transactions. Steps 1305-1340 may be executed on-demand, periodically, or in association with another operation.

In step 1345, a request for payment may be received. In step 1350, the type of payment may be evaluated to determine methods of payment that are accepted. For example, the request for payment may accept payments of value of stored value or virtual value sources without requiring that such sources be converted to cash.

In step 1355, funding priorities may be determined. For example, a user may specify that payments be funded by a first source up to a given threshold (such as a dollar amount or until the source is exhausted), followed by a second source up to a given threshold, a third source, and so on. In another example, payments payable by non-currency sources such as virtual value source that do not require conversion to cash may be prioritized. In yet another example, payments which accept a particular stored value without discount or conversion to cash may be prioritized.

In step 1360, it may be determined whether any non-currency sources are to be converted. If not, then method 1300 may proceed to step 1380. If so, then in step 1365 an amount specified during funding prioritization of the funding source may be exchanged into cash. Such conversion may rely upon services or modules for exchanging such funds into cash. In step 1370, the resulting amount of cash may be deposited into a prepaid cash account. In step 1375, the resulting amount may be transferred from the prepaid cash account into a destination account.

In step 1380, the amount of value determined during funding prioritization may be transferred from the funding source to the destination account.

In step 1385, it may be determined whether funding has been completed. If not, then steps 1355-1385 may be repeated. If so, then in step 1387 it may be determined whether a payment has been received. If so, then the type of payment may be determined in 1390. Such a type may include a cash payment, payment of stored value or virtual value. In step 1395, the value may be stored in a value source configured to hold the type of value received. Method 1300 may be optionally repeated as necessary.

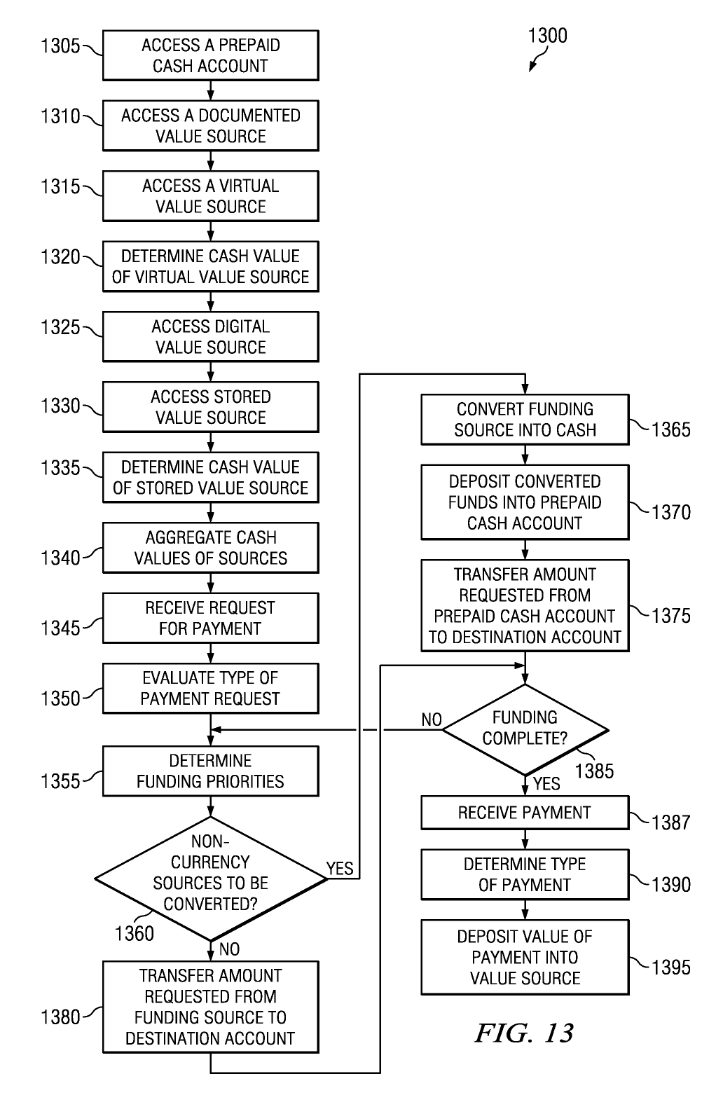

FIG. 14 is an example embodiment of a method 1400 for sending an instant UPS payment. In step 1405, a payment request may be received. Such a request may be received outside of a UPS, such as by a clerk, mail, or other message, or within a UPS such as by a notification in a UPS application.

In step 1410, the amount of value available in a UPS account may be determined. Such a step may be implemented by one or more steps of method 1300. In step 1415, a destination account may be selected. Such an account may be selected from known UPS contacts or from a search of UPS contacts. If no such account is selected, a pay-by-check transaction, an invitation to join UPS, or other offline payment information may be collected. In step 1425, the amount of value to be sent may be determined. In step 1427, funding priorities among one or more sources of a UPS account may be determined. In step 1430, an instant payment may be sent. If a pay-by-check option has been selected, a check may be issued to the specified recipient. In step 1435, the recipient may be notified of the pending deposit.

In step 1440, the value may be added to the destination account. Approval for the deposit may be required, depending upon the preferences of the destination account. In step 1445, the destination account may be added to the source UPS contact list, depending upon the preferences of the destination and the source. In step 1450, the source account may be added to the destination UPS contact list, depending upon the preferences of the destination and the source.

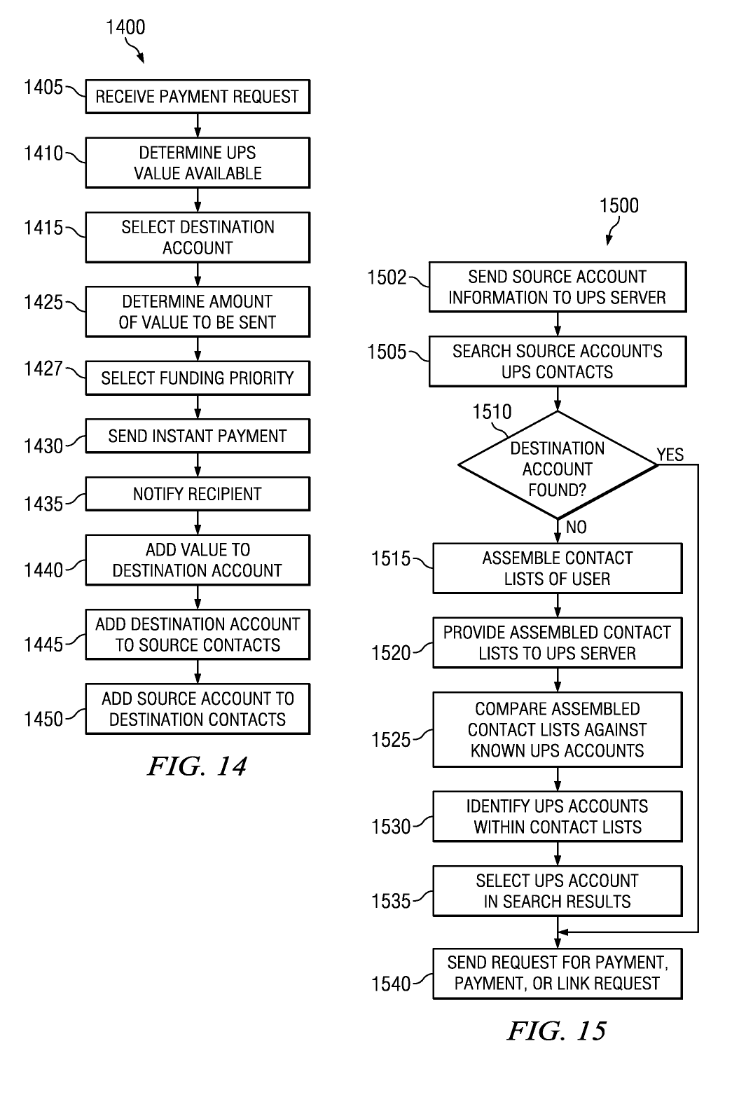

FIG. 15 is an example embodiment of a method 1500 for finding a destination UPS account for sending a payment or payment request. In step 1502, contact information, such as phone number, associated with the source account may be sent to a UPS server. Depending upon the privacy configurations of source account, the source account may be listed in searches by other users of a UPS to find contacts with which to share payments and payment requests. In step 1505, a source account's UPS contact list may be searched for the destination UPS account. In step 1510, if the account was found, then the method may proceed to step 1535. If the account was not found, then in step 1515, various other contact lists associated with a user of source account may be collected. In step 1520, these assembled contact lists may be submitted to a UPS server. In step 1525, these assembled contact lists may be compared against contact information for accounts within UPS that have been designated as searchable. In step 1530, any such UPS accounts associated with the contact information in the assembled contact lists may be identified as UPS accounts with which a connection may be made. In step 1535, one or more of the UPS accounts identified in step 1530 may be selected. In step 1540, a request for payment, payment, or link request may be sent to the selected account. Method 1500 may be performed, for example, upon launch of a UPS application, upon a command to send funds, upon demand, or any other suitable time.

Methods 1300, 1400, and 1500 may be implemented using the system of FIGS. 1-12, or any other system operable to implement methods 1300, 1400, and 1500. As such, the preferred initialization point for methods 1300, 1400, and 1500 and the order of its steps may depend on the implementation chosen. In some embodiments, some steps may be optionally omitted, repeated, or combined. In some embodiments, some steps of methods 1300, 1400, and 1500 may be executed in parallel with other steps of methods 1300, 1400, and 1500. In certain embodiments, methods 1300, 1400, and 1500 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other electromagnetic and/or optical carriers; and/or any combination of the foregoing.

Although the present disclosure has been described in detail, it should be understood that various changes, substitutions, and alterations can be made hereto without departing from the spirit and the scope of the disclosure as defined by the appended claims.

What is claimed is:

1. A method for unified payment, comprising:
identifying a unified account;
determining a cash value source of the unified account;
determining a non-cash value source of the unified account;
presenting a combined value of the cash value source and the non-cash value source, wherein the combined value is expressed in terms of cash.

2. The method of claim 1, wherein the non-cash value source is denominated in non-legal tender units.

3. The method of claim 1, wherein the non-cash value source is denominated in legal tender currency-based units.

4. The method of claim 1, further comprising determining a priority identifying an order of the cash value source, non-cash value source, and one or more other value sources of the unified account.

5. The method of claim 4, wherein a non-cash value source denominated in legal tender currency-based units is prioritized over a non-cash value source denominated in non-legal tender units

6. The method of claim 1, further comprising transferring a portion of the combined value to a destination account, the portion of the combined value including a portion of the non-cash value source.

7. The method of claim 1, further comprising:
converting a portion of the non-cash value source to cash; and
transferring a portion of the combined value to a destination account, the portion of the combined value including a portion of the converted non-cash value source.

8. The method of claim 1, further comprising:
determining a destination account; and
transferring a portion of the combined value to the destination account, the portion of the combined value including a portion of the non-cash value source;
wherein the portion of the non-cash value source was selected based on the identity of the destination account.

9. The method of claim 1, further comprising transferring a portion of the combined value to a destination account, the portion of the combined value including a portion of the non-cash value source preserved in its non-cash value state.

10. An article of manufacture comprising:
a non-transitory computer readable medium; and
computer-executable instructions carried on the computer readable medium, the instructions readable by a processor, the instructions, when read and executed, for causing the processor to:
identify a unified account;
determine a cash value source of the unified account;
determine a non-cash value source of the unified account; and
present a combined value of the cash value source and the non-cash value source, wherein the combined value is expressed in terms of cash.

11. The article of claim 10, wherein the non-cash value source is denominated in non-legal tender units.

12. The article of claim 10, wherein the non-cash value source is denominated in legal tender currency-based units.

13. The article of claim 10, further comprising instructions for causing the processor to determine a priority identifying an order of the cash value source, non-cash value source, and one or more other value sources of the unified account.

14. The method of claim 13, wherein a non-cash value source denominated in legal tender currency-based units is prioritized over a non-cash value source denominated in non-legal tender units

15. The article of claim 10, further comprising instructions for causing the processor to transfer a portion of the combined value to a destination account, the portion of the combined value including a portion of the non-cash value source.

16. The article of claim 10, further comprising instructions for causing the processor to:
convert a portion of the non-cash value source to cash; and
transfer a portion of the combined value to a destination account, the portion of the combined value including a portion of the converted non-cash value source.

17. The article of claim 10, further comprising instructions for causing the processor to:
determine a destination account; and
transfer a portion of the combined value to the destination account, the portion of the combined value including a portion of the non-cash value source;
wherein the portion of the non-cash value source was selected based on the identity of the destination account.

18. The article of claim 10, further comprising instructions for causing the processor to transfer a portion of the combined value to a destination account, the portion of the combined value including a portion of the non-cash value source preserved in its non-cash value state.

19. An apparatus, comprising:
a wireless communications module;
a processor communicatively coupled to the wireless communications module;
a non-transitory computer readable medium; and
computer-executable instructions carried on the computer readable medium, the instructions readable by the processor, the instructions, when read and executed, for causing the processor to:
identify a unified account;
determine a cash value source of the unified account;
determine a non-cash value source of the unified account; and
present a combined value of the cash value source and the non-cash value source, wherein the combined value is expressed in terms of cash;
wherein access to the unified account is provided by the apparatus through the wireless communications module.

20. The apparatus of claim 19, wherein the non-cash value source is denominated in non-legal tender units.

21. The apparatus of claim 19, wherein the non-cash value source is denominated in legal tender currency-based units.

22. The apparatus of claim 19, further comprising instructions for causing the processor to determine a priority identifying an order of the cash value source, non-cash value source, and one or more other value sources of the unified account.

23. The apparatus of claim 22, wherein a non-cash value source denominated in legal tender currency-based units is prioritized over a non-cash value source denominated in non-legal tender units

24. The apparatus of claim 19, further comprising instructions for causing the processor to transfer a portion of the combined value to a destination account, the portion of the combined value including a portion of the non-cash value source.

25. The apparatus of claim 19, further comprising instructions for causing the processor to:
convert a portion of the non-cash value source to cash; and
transfer a portion of the combined value to a destination account, the portion of the combined value including a portion of the converted non-cash value source.

26. The apparatus of claim 19, further comprising instructions for causing the processor to:
determine a destination account; and
transfer a portion of the combined value to the destination account, the portion of the combined value including a portion of the non-cash value source;
wherein the portion of the non-cash value source was selected based on the identity of the destination account.

27. The apparatus of claim 19, further comprising instructions for causing the processor to transfer a portion of the combined value to a destination account, the portion of the combined value including a portion of the non-cash value source preserved in its non-cash value state.
